(19) United States
(12) Patent Application Publication
(10) Pub. No.: US 2009/0292377 A1
(43) Pub. Date: Nov. 26, 2009

(54) MULTI-CHANNEL AUDIO OUTPUT DEVICE

(75) Inventors: Masahiro YAMASAKI, Osaka (JP); Ryoji SUZUKI, Nara (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Osaka (JP)

(21) Appl. No.: 12/425,474

(22) Filed: Apr. 17, 2009

(30) Foreign Application Priority Data
Apr. 17, 2008 (JP) 2008-107654

(51) Int. Cl. G06F 17/00

(52) U.S. Cl. 700/94

(57) ABSTRACT

This audio output device can output audio signals with mutually different numbers of channels through multiple audio output sections on a channel-by-channel basis. The device has a first audio output mode for outputting a first audio signal with a first number of channels through the audio output sections and a second audio output mode for outputting second and third audio signals with second and third numbers of channels, respectively, which are both smaller than the first number, through the audio output sections simultaneously. The audio output sections for use to output the second and third audio signals in the second audio mode are used in the first audio mode to output the first audio signal.

### BACKGROUND OF THE INVENTION

1. Field of the Invention

The present invention relates to a multi-channel audio output device for use in Blu-ray Disc players and Blu-ray Disc recorders, for example.

2. Description of the Related Art

Recently, more and more movie package media have been put on sale as Blu-ray Discs, instead of DVDs, because a Blu-ray Disc has a storage capacity that is big enough to store even a whole high-definition movie in itself. Similar trends are also observed in audio systems. That is to say, 5.1 channel (ch) surround audio systems for DVDs have been replaced by 7.1ch lossless surround audio recorded discs more and more often these days, and there is an increasing demand for 7.1ch audio playback. In these notations, “0.1ch” means a so-called “subwoofer” that is a bass-only channel.

For example, Japanese Patent Application Laid-Open Publication No. 2004-23187 discloses a sound image localization processor that enables a 5.1ch audio reproduction system to achieve as high sound field effects as what is achieved by a 7.1ch audio reproduction system. FIG. 15 illustrates an exemplary configuration for the processor disclosed in that document.

Hereinafter, it will be described how the conventional sound image localization processor shown in FIG. 15 operates. On receiving a 7.1ch audio digital signal, that processor instructs a unique signal processor to perform the processing of getting such sound field effects that are as high as what is achieved by a 7.1ch reproduction system produced by a 5.1ch reproduction system.

For example, if a Blu-ray Disc is used, that processor can reproduce an audio signal with a max of 7.1 channels. The 7.1ch audio signal consists of a front signal 301, a surround signal 302, a center subwoofer signal 303 and a surround back signal 304. These signals are obtained as a result of the reproduction processing done by a Blu-ray Disc player.

The front signal 301 as a digital signal is D/A converted by a second D/A converter 102 into an analog signal. In the meantime, the surround signal 302 as a digital signal is input to an adder 502. The center subwoofer signal 303 as a digital signal is D/A converted by a fourth D/A converter 104 into an analog signal. And the surround back signal 304 as a digital signal is subjected to signal processing by a signal processor 501 and then input to the adder 502. The output signal of the adder 502 is D/A converted by a third D/A converter 103 into an analog signal. By providing the additional signal processor 501, even the 5.1ch audio playback environment can virtually produce the sound field effects of 7.1ch audio.

On the other hand, Japanese Patent Application Laid-Open Publication No. 2007-96442 discloses an audio signal processor that can switch from multi-channel into 2ch, or vice versa, without deteriorating a DVD audio signal in a 5.1ch audio reproduction system. FIG. 16 illustrates an exemplary configuration for the processor disclosed in that document.

Hereinafter, it will be described how the processor shown in FIG. 16 operates. This processor performs processing on a 5.1ch digital audio signal to be written on a DVD, for example.

A surround signal 302 as a digital signal is D/A converted into an analog signal by a third D/A converter 103. Likewise, a center subwoofer signal 303 as a digital signal is D/A converted into an analog signal by a fourth D/A converter 104.

A down mixed 2ch signal 305 is a 2ch signal obtained by down-mixing a 5.1ch digital signal consisting of a 2ch front signal 301, the 2ch surround signal 302, and the 0.1ch center subwoofer signal 303. The front signal 301 and the down mixed 2ch signal 305 are input as two digital signals to a second switch 202, which selectively outputs one of these two signals in accordance with a second control signal 402. The control signal 402 is a signal to switch a 2ch loudspeaker system into a 5.1ch one, or vice versa. Specifically, the second switch 202 outputs the front signal 301 if the loudspeaker system is 5.1ch but outputs the down mixed 2ch signal 305 if the loudspeaker system is 2ch.

According to this configuration, the second D/A converter 102 can output the front signal as a surround signal if the loudspeaker system is 5.1ch and output an audio signal, obtained by down-mixing 5.1ch into 2ch, if the loudspeaker system is 2ch.

An audio output device having a configuration as shown in FIG. 17, which is a modified example of the one illustrated in FIG. 16, is also known. Unlike the counterpart shown in FIG. 16, the device shown in FIG. 17 is designed such that the down mixed 2ch signal 305 is input to not only the second switch 202, which selects either that signal 305 or the front signal 301, but also a first D/A converter 101. The down mixed 2ch signal 305 as a digital signal is D/A converted into an analog signal by the first D/A converter 101. That is why the first D/A converter 101 always outputs such a signal that has been down-mixed from 5.1ch into 2ch.

A 5.1ch loudspeaker system and a 2ch loudspeaker system can be connected to this device at the same time and independently of each other. While the down-mixed 2ch signal is output continuously, the 5.1ch signal can also be output. This device does not have to change the settings or connections of its components, no matter whether the audio is to be reproduced with 2ch or 5.1ch.

However, each of the devices described above still has plenty of room for improvement, considering its user friendliness.

For example, the device shown in FIG. 15 is designed such that the signal processor 501 performs signal processing on the surround back signal 304 and then the processed signal is added to the surround signal 302. However, this is just a technique for producing 7.1ch sound field effects using a 5.1ch audio playback environment. In other words, this is only a technique for making a virtual playback and cannot produce real 7.1ch audio surround effects. As Blu-ray Discs on which a 7.1ch audio signal can be recorded have become increasingly popular nowadays, the device shown in FIG. 15 has become more and more meaningless for users who already have had a 7.1ch loudspeaker system set up.

The device shown in FIG. 16, on the other hand, can switch the output of the D/A converter 102 between the down-mixed 2ch signal 305 and the front signal 301 when connected to a 5.1ch loudspeaker system and a 2ch loudspeaker system. Stated otherwise, however, this means that either just a part of the 5.1ch loudspeaker system or only a part of the 2ch loudspeaker system can be connected to the D/A converter 102. That is why the user needs to change the settings and connections of its components depending on whether he or she wants to make playback with 2ch or 5.1ch.

Furthermore, the device with the configuration shown in FIG. 17 cannot play back 7.1ch audio for Blu-ray Discs, which have recently become mainstream products on the market. This is because to reproduce 7.1ch audio while securing a path for outputting the down-mixed 2ch signal continuously, a D/A converter (DAC) for processing a (2ch) surround back signal, which is different from the surround signal, should be added. In that case, the number of circuits and terminals required would increase, thus making it impossible to cut down the cost.

It is therefore an object of the present invention to provide an audio output device that not only can be used in a multi-channel playback environment, in which there are a number of sound sources, but also does not require the user to change the settings or connections even in a playback environment in which there are fewer channels.

### SUMMARY OF THE INVENTION

An audio output device according to the present invention can output audio signals with mutually different numbers of channels through multiple audio output sections on a channel-by-channel basis. The device has a first audio output mode for outputting a first audio signal with a first number of channels through the audio output sections and a second audio output mode for outputting second and third audio signals with second and third numbers of channels, respectively, which are both smaller than the first number, through the audio output sections simultaneously. The audio output sections for use to output the second and third audio signals in the second audio mode are used in the first audio mode to output the first audio signal.

The first audio signal may have 7.1 channels, the second audio signal may have 5.1 channels and the third audio signal may have 2 channels.

Among the audio output sections, the audio output section for outputting the third audio signal in the second audio output mode may be the same as the audio output section for outputting a surround back signal of the first audio signal in the first audio output mode.

The sum of the second and third numbers of channels may be equal to or smaller than the first number of channels.

The audio output device of the present invention has a first audio output mode for outputting a first audio signal with a first number of channels and a second audio output mode for outputting second and third audio signals with second and third numbers of channels, respectively, which are both smaller than the first number, simultaneously. If the sound source has the first number of channels, a user who has the first number of channels can reproduce the audio signal in the first number of channels with high fidelity, but even a user who has a smaller number of loudspeakers than the first number can also play back the sound source in the second audio output mode with a fewer number of channels.

In particular, in the second audio output mode, an audio signal with the second number of channels and an audio signal with the third number of channels can be output simultaneously and independently of each other. In other words, a loudspeaker system, of which the number of channels is the sum of the second and third numbers of channels, may be connected to the audio output device. As a result, the output of a TV set with the same number of loudspeakers as the second number of channels and that of an AV amplifier, to which the same number of loudspeakers as the third number of channels are connected, can be both selected at the same time.

On top of that, the audio output sections for use to output the second and third audio signals in the second audio output mode are also used to output the first audio signal in the first audio output mode. That is why even without providing a greater number of audio output sections than that of audio output sections for outputting the first audio signal, the output of a TV set with the same number of loudspeakers as the second number of channels and that of an AV amplifier, to which the same number of loudspeakers as the third number of channels are connected, can be both selected at the same time.

Furthermore, the sum of the second and third numbers of channels is equal to or smaller than the first number of channels. Therefore, if a user who has a playback environment that uses the second audio output mode has purchased additional loudspeakers and connected them to the AV amplifier described above, he or she can easily switch to a playback environment in the first audio output mode.

### BRIEF DESCRIPTION OF THE DRAWINGS

FIG. 1 is a block diagram illustrating a configuration for an audio output device 100 as a first specific preferred embodiment of the present invention.

FIG. 2 illustrates a configuration for an AV decoder 154.

FIG. 3 is a schematic representation illustrating the connection and configuration around the first switch SW1 (201) shown in FIG. 2.

FIG. 4 illustrates how the audio output device 100 of the first preferred embodiment may be connected when used in an environment in which a 7.1ch loudspeaker system is installed.

FIG. 5 illustrates how the audio output device 100 of the first preferred embodiment may be connected when used in an environment in which a 2ch TV set 603 and a 5.1ch loudspeaker system are installed.

FIG. 6 illustrates exemplary dialog boxes 701 and 702 that prompt the user to choose, as the analog audio output mode, either 2ch+5.1ch or 7.1ch while setting the operating environment of the audio output device 100.

FIG. 7 illustrates an exemplary alert to be displayed to the user when the 7.1ch is chosen.

FIG. 8 illustrates an exemplary alert to be displayed to the user when the 2ch+5.1ch are chosen.

FIG. 9 is a flowchart showing the procedure of processing to get done by the audio output device 100.

FIG. 10 is a flowchart showing the procedure of processing to get done by the audio output device 100.

FIG. 11 is a flowchart showing the procedure of processing to get done by the audio output device 100.

FIG. 12 is a schematic representation illustrating a connection and configuration for an audio output device 200 as a second specific preferred embodiment of the present invention.

FIG. 13 illustrates how the audio output device 200 of the second preferred embodiment may be connected when used in an environment in which a 2ch loudspeaker system is installed.

FIG. 14 illustrates exemplary dialog boxes 701 and 702 that prompt the user to choose, as the analog audio output mode, 2ch, 2ch+5.1ch or 7.1ch while setting the operating environment of the audio output device 200.

FIG. 15 illustrate exemplary configurations for conventional devices.

### DETAILED DESCRIPTION OF PREFERRED EMBODIMENTS

Hereinafter, preferred embodiments of a multi-channel audio output device according to the present invention will be described with reference to the accompanying drawings. The multi-channel audio output device may be implemented, for example, as a BD recorder with a built-in HDD, which can record a digital broadcast on either a Blu-ray Disc (BD) or a hard disk and which can play back the digital broadcast recorded. The BD recorder can also play a BD-ROM on which a 7.1ch audio signal has been recorded.

### EMBODIMENT 1

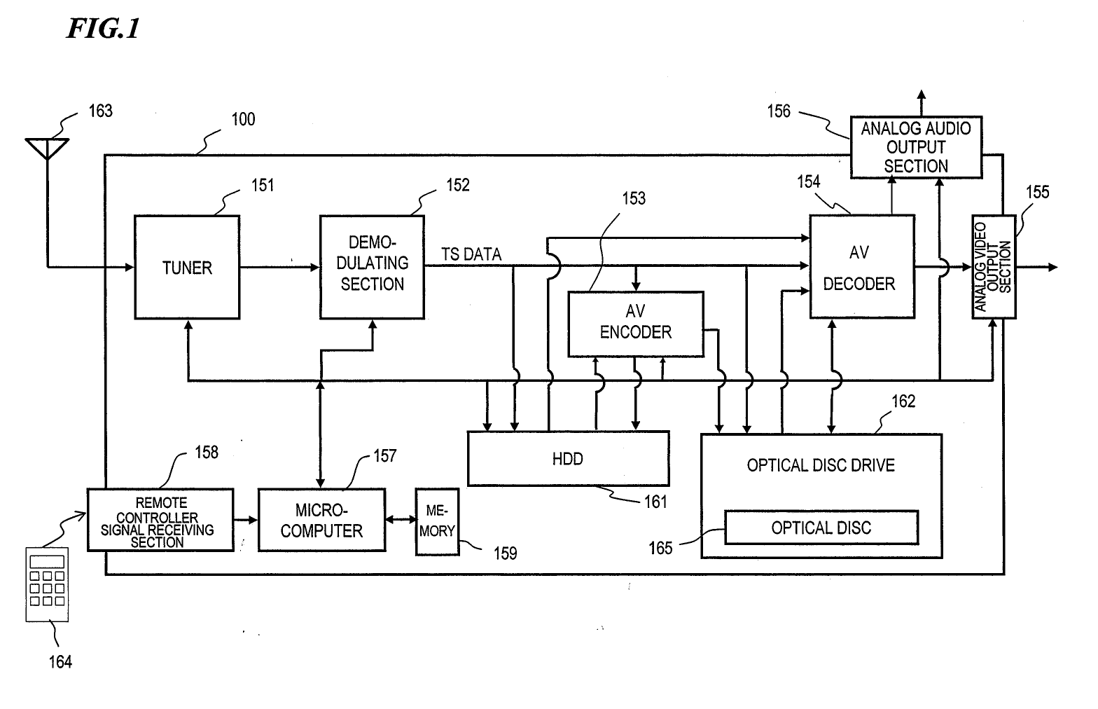

FIG. 1 is a block diagram illustrating a configuration for a multi-channel audio output device 100 (which will be simply referred to herein as an “audio output device 100”) as a first specific preferred embodiment of the present invention. The audio output device 100 includes a tuner 151, a demodulating section 152, an AV encoder 153, an AV decoder 154, an analog video output section 155, an analog audio output section 156, a microcomputer 157, a remote controller signal receiving section 158, a memory 159, a hard disk drive (HDD) 161, an optical disc drive 162 and a broadcast receiving antenna 163.

The broadcast receiving antenna 163 receives broadcasts as radio waves. The tuner 151 selects any of the broadcast signals received at the broadcast receiving antenna 163. The demodulating section 152 demodulates the broadcast signal selected by the tuner 151 into transport stream (TS) data.

The AV encoder 153 transforms the TS data that has been demodulated by the demodulating section 152, thereby generating AV data to be written as compressed data.

On the HDD 161, either the TS data demodulated by the demodulating section 152 or the AV data generated by the AV encoder 153 is written. The optical disc drive 162 writes either the TS data demodulated by the demodulating section 152 or the AV data generated by the AV encoder 153 on a given optical disc 165. Also, the optical disc drive 162 reads the AV data that is stored on the given optical disc 165. Examples of the optical discs 165 include recordable discs such as a BD-R and a BD-RE and a read-only one such as a BD-ROM.

The AV decoder 154 decodes the TS data demodulated by the demodulating section 152, the AV data read by the HDD 161, or the AV data read by the optical disc drive 162 into a predetermined AV signal.

The analog video output section 155 receives the analog video signal from the AV decoder 154 and then outputs it. Optionally, besides the analog video output section 155, a terminal such as an HDMI terminal that can output a digital video signal and a circuit may also be provided.

The analog audio output section 156 receives the analog audio signal from the AV decoder 154 and then outputs it. As will be described later, the analog audio output section 156 has D/A converter(s) and audio output terminals for respective channels. One D/A converter may be provided for either each channel or each pair of channels. On the other hand, one audio output terminal is provided for each single channel. Optionally, besides the analog audio output section 156, a terminal such as an optical output terminal or an HDMI terminal that can output a digital audio signal and a circuit may also be provided.

The microcomputer 157 controls the respective operations of the tuner 151, demodulating section 152, AV encoder 153, AV decoder 154, output section 155, HDD 161 and optical disc drive 162, thereby controlling the overall operation of the audio output device 100.

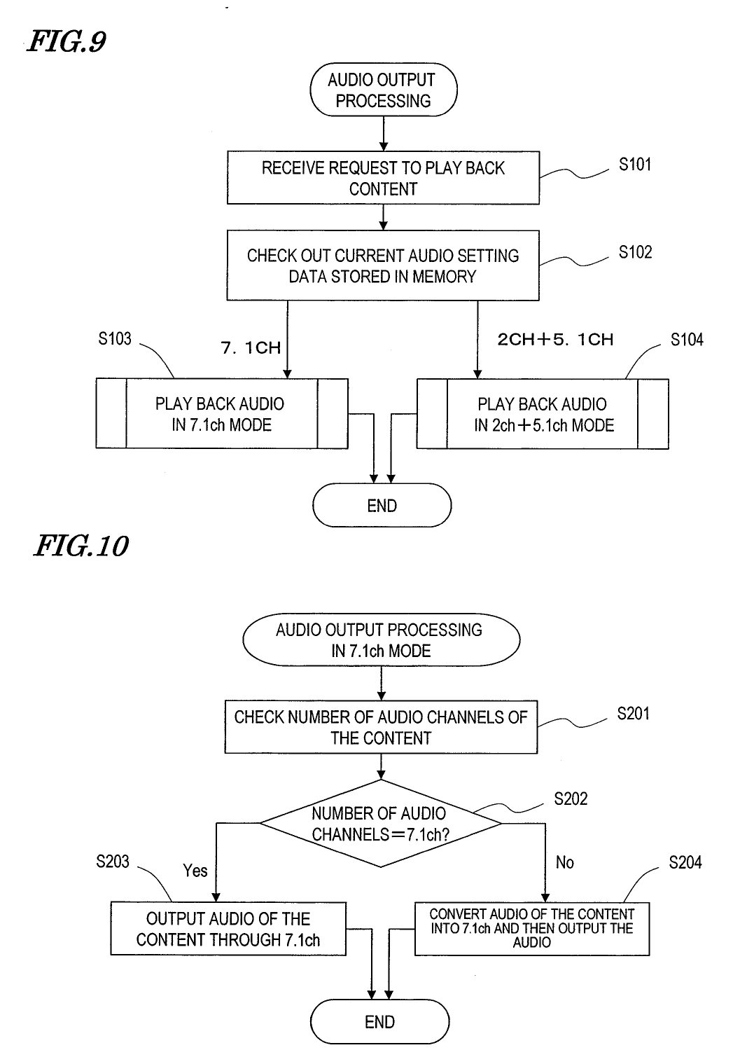

When the audio output device 100 is started, a computer program describing the procedure of operations is run on the memory 159. For example, a computer program represented by the flowchart shown in FIGS. 9 to 16 may be run on the memory 159. Such a computer program may be stored on an optical disc or a flash memory card, for example, or may also be transmitted over a network. Optionally, the memory 159 could be used as a work memory when the AV encoder 153 or the AV decoder 154 operates.

A remote controller 164 sends out an infrared control signal to control the operation of the audio output device 100 and the remote controller signal receiving section 158 receives the infrared control signal from the remote controller 164. By using this remote controller 164, the user can control the audio output device 100.

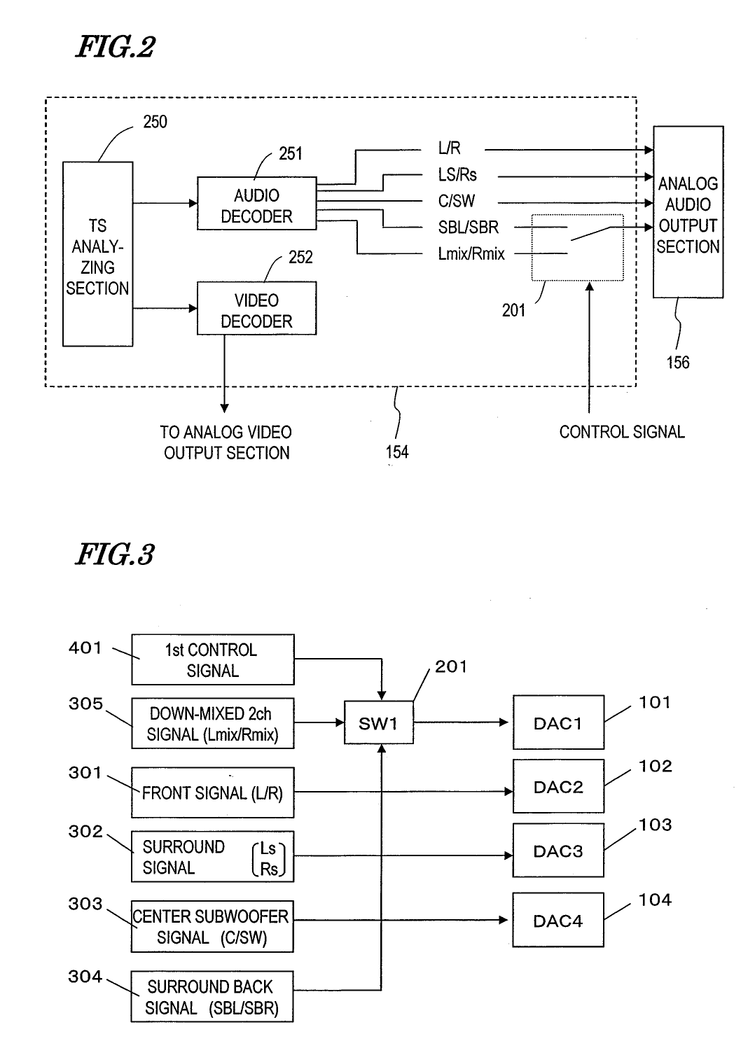

FIG. 2 illustrates a configuration for the AV decoder 154, which includes a switch 201, a TS analyzing section 250, an audio decoder 251, and a video decoder 252.

The TS analyzing section 250 receives the TS data from the demodulating section 152, analyzes the data structure of the TS data, and then separates and outputs the audio and video data streams that are multiplexed in the TS data. In the output data streams, the audio data stream separated is called an “audio elementary stream”, while the video data stream separated is called a “video elementary stream”.

The video decoder 252 decodes the video elementary stream and outputs the decoded stream to the analog video output section 155.

On the other hand, the audio decoder 251 decodes the audio elementary stream and outputs the decoded stream to the analog audio output section 156. Specifically, the audio decoder 251 gets that decoding done in the following manner.

The audio elementary stream includes a 7.1ch digital audio signal, for example. And the audio decoder 251 separately outputs respective components of the digital audio signal on a channel-by-channel basis. That is to say, the channels of the audio signal to be output consist of two channels for front left and right (L/R), two channels for surround left and right (LS/RS), 1.1 channels for center and subwoofer (C/SW) and two channels for surround back left and right (SBL/SBR).

The audio decoder 251 further carries out mixing processing using those 7.1 channels (i.e., down mixing processing) and further outputs audio signal components representing two channels for down-mixed left and right (Lmix/Rmix). The down mix processing gets done by converting 7.1ch audio into 5.1ch audio and then into 2ch audio. Specifically, the down mix processing is carried out by the following equations, the left side of which represents the channel output generated.

First, the 7.1ch audio is converted into 5.1ch audio by the following Equations (1):

L=L

R=R

LS=LS+SBL (1)

RS=RS+SBR

C=C

SW=SW

Next, the 5.1ch audio is converted into 2ch audio by the following Equations (2):

Lmix=L+K·C+K·LS

Rmix=R+K·C+K·RS (2)

where K=0.707 (−3 dB). In Equations (2), the subwoofer channel SW is not used but discarded.

As a result of the processing represented by these Equations (1) and (2), a down-mixed 2ch signal can be obtained.

As shown in FIG. 2, according to this preferred embodiment, a signal component representing one of the surround back left and right channels (SBL/SBR) and a signal component representing one of the down-mixed left and right channels (SBL/SBR) are selectively output. Those outputs are selected by the switch 201 shown in FIG. 2. The switch 201 is controlled in accordance with a control signal supplied from the microcomputer 157 (see FIG. 1).

It should be noted that only the control signal for the switch 201 is shown in FIG. 2 for the sake of convenience. Actually, however, the control signal is supplied from the microcomputer 157 to the TS analyzing section 250, the audio decoder 251 and the video decoder 252 to control their operations. FIG. 3 is a schematic representation illustrating the connection and configuration around the first switch SW1 (201) shown in FIG. 2. SW 201 is a component of the AV decoder 154, and DAC1 101 to DAC4 104 are components of the analog audio output section 156 shown in FIG. 1. The analog audio output section 156 includes output terminals (not shown) for respective channels, and the outputs of DAC1 101 to DAC4 104 are connected to those output terminals.

For the sake of convenience, the L/R 2ch signal, the LS/RS 2ch signal, the C/SW 1.1ch signal, and the SBL/SBR 2ch signal will be referred to herein as a “front signal 301”, a “surround signal 302”, a “center subwoofer signal 303” and a “surround back signal 304”, respectively.

The front signal 301 as a digital signal is D/A converted into an analog signal by the second D/A converter 102. Likewise, the surround signal 302 is D/A converted into an analog signal by the third D/A converter 103 and the center subwoofer signal 303 is D/A converted into an analog signal by the fourth D/A converter 104.

Meanwhile, the down-mixed 2ch signal 305 and the surround back signal 304 are input to the first switch SW1 201, which is controlled, and has its output signal selected, in accordance with a first control signal 401.

If the user uses this audio output device 100 with a 7.1ch loudspeaker system, a control signal 401 instructing that the surround back signal 304 be output is supplied to the switch 201. On the other hand, if the user uses this audio output device 100 with a 5.1ch or 2ch loudspeaker system, then a control signal 401 instructing that the down-mixed 2ch signal 305 be output is supplied to the switch 201. That is to say, the control signal 401 changes depending on whether the user has a 7.1ch loudspeaker system or a loudspeaker system with a fewer number of channels. The user may enter the type of the loudspeaker system he or she owns into this audio output device 100 while setting the operating environment of the device 100, for example. Those settings are stored as audio setting data in the memory 109.

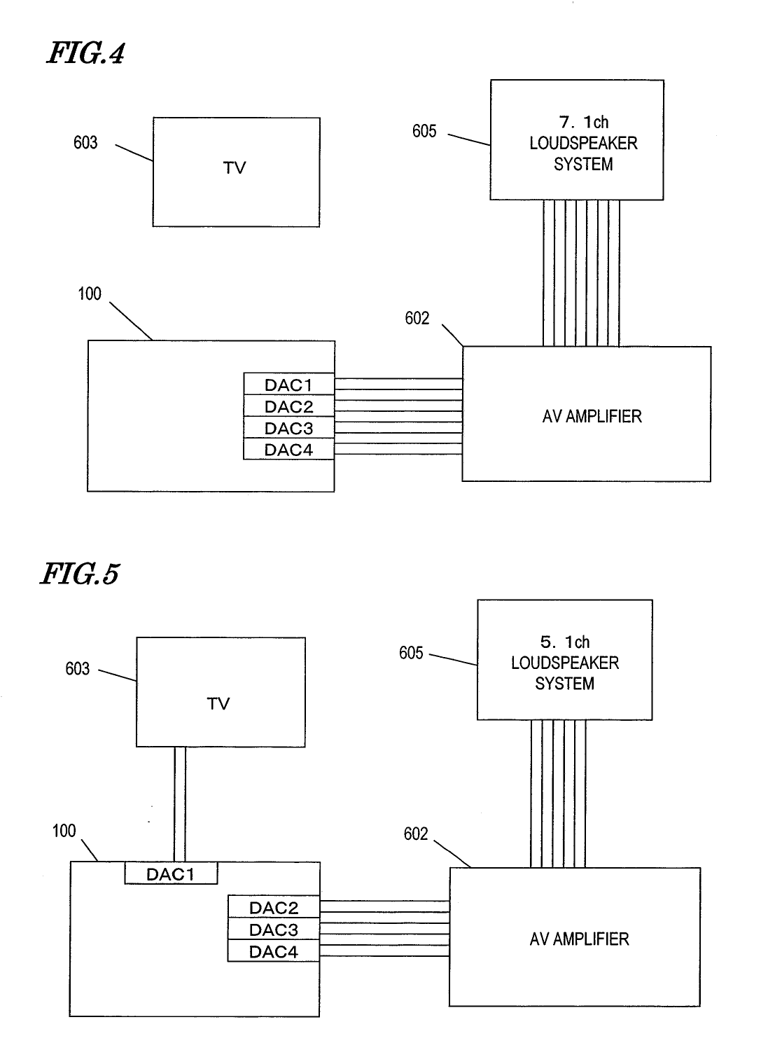

FIG. 4 illustrates how the audio output device 100 of this preferred embodiment may be connected when used in an environment in which a 7.1ch loudspeaker system is installed. The outputs of all D/A converters (DAC1 through DAC4), i.e., analog 7.1ch outputs, are connected to the analog 7.1ch input terminals of an AV amplifier 602. And the outputs of the AV amplifier 602 are connected to a 7.1ch loudspeaker system 605.

According to the configuration shown in FIG. 4, the user selects the 7.1ch analog audio outputs while setting the operating environment of the audio output device 100. As a result, this audio output device 100 is compatible with 7.1ch audio of a Blu-ray Disc.

On the other hand, FIG. 5 illustrates how the audio output device 100 of this preferred embodiment may be connected when used in an environment in which a 2ch TV set 603 and a 5.1ch loudspeaker system are installed.

In that case, the output of the first D/A converter (DAC1) is connected to the analog 2ch audio input of the TV set 603. Meanwhile, the respective outputs of the second, third and fourth D/A converters 102, 103 and 104 are connected to the analog 5.1ch inputs (front, surround, center and subwoofer) of the AV amplifier 602. And the outputs of the AV amplifier 602 are connected to the 5.1ch loudspeaker system 605.

According to the configuration shown in FIG. 5, the user selects 2ch+5.1ch analog audio outputs while setting the operating environment of the audio output device 100. As a result, the signal components of 2ch and 5.1ch are output at the same time. Consequently, under such a connection environment, the user can enjoy a movie or any other content on a Blu-ray Disc, on which 7.1ch audio is recorded, with the 2ch audio of the TV set 603 and the audio of the AV amplifier 602 and the 5.1ch loudspeaker system 605 even without changing the settings or connections of the components.

As for a DVD on which 5.1ch audio is recorded, the user can enjoy the 2ch audio of the TV set 603 by down-mixing 5.1ch into 2ch by Equations (2). In this case, the user can also enjoy the audio of the AV amplifier 602 and the 5.1ch loudspeaker system 605 according to his or her preference.

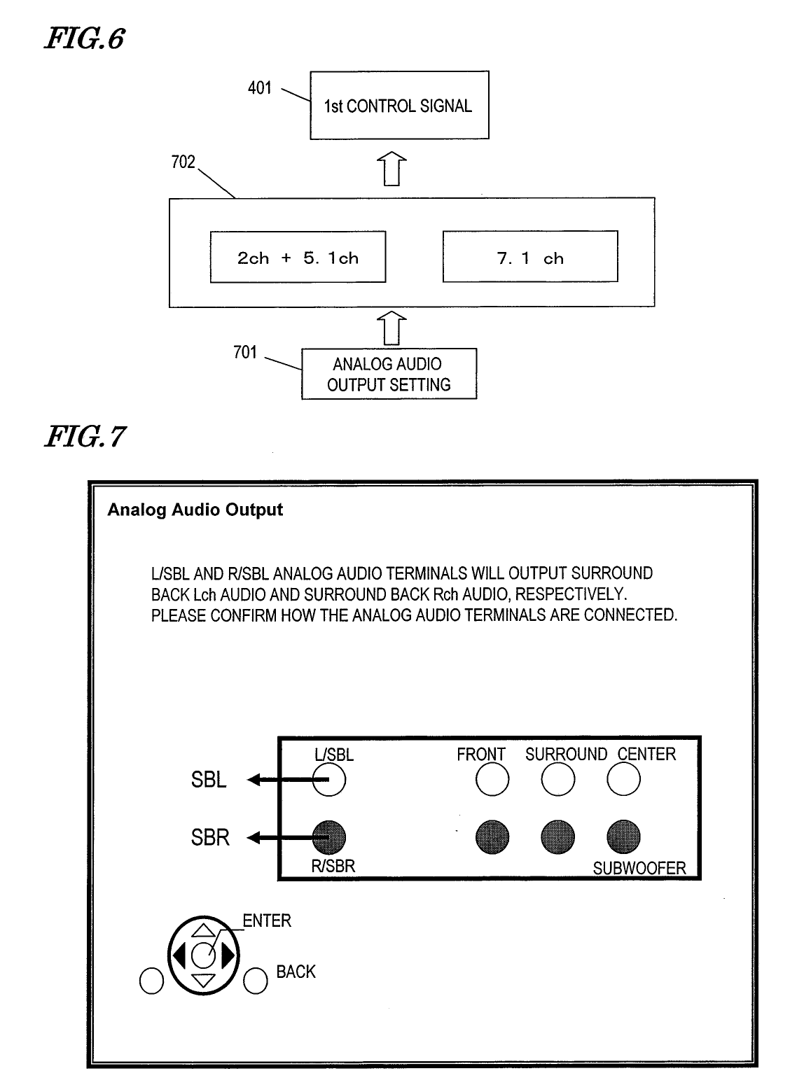

FIG. 6 illustrates exemplary dialog boxes 701 and 702 that prompt the user to choose, as the analog audio output mode, either 2ch+5.1ch or 7.1ch while setting the operating environment of the audio output device 100. This choice can be made with the user interface of the audio output device 100, for example. An analog audio output setting option 701 is provided as one of various operating environment setting options of the audio output device 100. When the user picks up that option, the dialog box 702 for making a choice is displayed. And if the user chooses either the 2ch+5.1ch or 7.1ch, the first control signal 401 is determined.

Specifically, if the user chooses 7.1ch, the first switch outputs the surround back signal 303 in accordance with the control signal 401. FIG. 7 illustrates an exemplary alert to be displayed to the user when the 7.1ch is chosen. As shown in FIG. 7, the user is told that the left and right surround back signal components 303 (SBL and SBR) will be output from the output terminals L/SBL and R/SBR associated with DAC1 101 shown in FIG. 3. By reading this alert, the user can confirm how the surround back signal is connected in his or her own 7.1ch loudspeaker system.

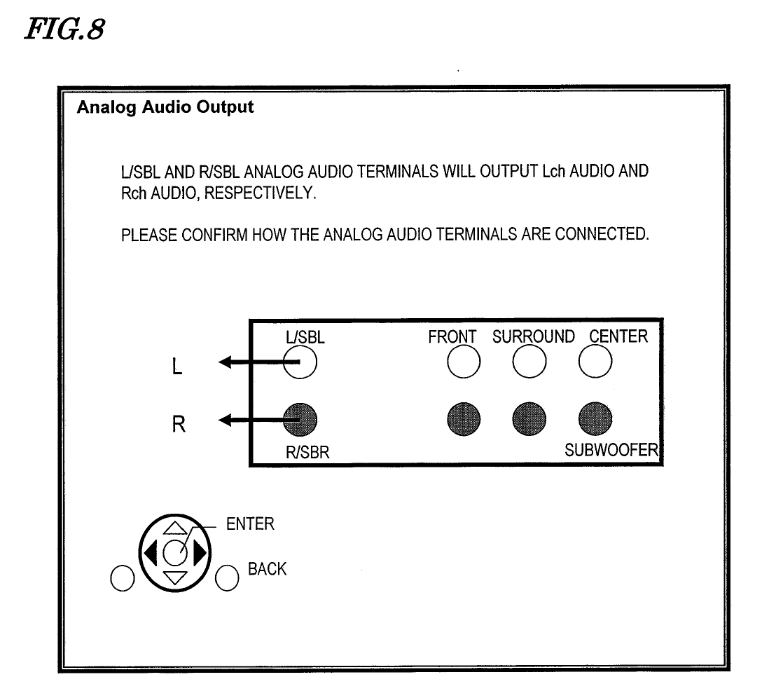

On the other hand, if the user chooses 2ch+5.1ch in FIG. 6, the first switch 201 will output the down-mixed 2ch signal in accordance with the control signal 401. FIG. 8 illustrates an exemplary alert to be displayed to the user when the 2ch+5.1ch are chosen. As shown in FIG. 8, the user is told that the left and right audio signal components (L and R) will be output from the output terminals L/SBL and R/SBR associated with DAC1 101 shown in FIG. 3. This audio signal is the down-mixed 2ch signal 305. By reading this alert, the user can confirm how the down-mixed signal is connected in his or her own loudspeaker system.

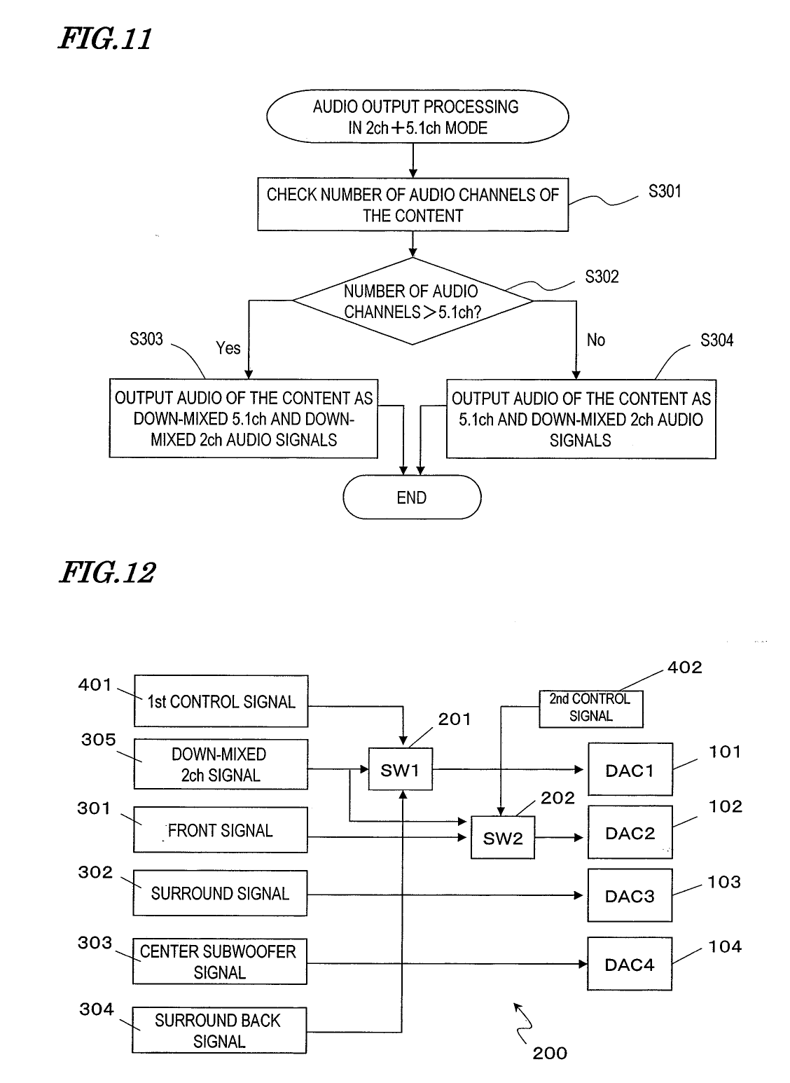

FIGS. 9 through 11 are flowcharts showing the procedure of processing to get done by the audio output device 100. As a result of the processing shown in FIG. 9, either the processing shown in FIG. 10 or the one shown in FIG. 11 is carried out. As will be described later, the instructions issued by the microcomputer 157 are conveyed to respective components as a control signal. On receiving the control signal, the respective components operate and perform their functions in accordance with that control signal.

First of all, in Step S101, the remote controller signal receiving section 158 receives a request to play back a content from the user who holds the remote controller 164. In response to that request, the microcomputer 157 checks out the data about the current audio settings that is stored in the memory 159. The audio setting data indicates whether the user has chosen 7.1ch or 2ch+5.1ch through the dialog box shown in FIG. 6. If the audio setting data indicates that he or she has chosen 7.1ch, then the process advances to Step S103, in which the microcomputer 157 plays back the audio in 7.1ch mode. On the other hand, if the audio setting data indicates that he or she has chosen 2ch+5.1ch, then the process advances to Step S104, in which the microcomputer 157 plays back the audio in 2ch+5.1ch mode. After that, the process ends.

The details of the processing step S103 are shown in FIG. 10, which is a flowchart showing the procedure of outputting audio in the 7.1ch mode.

First, in Step S201, the microcomputer 157 checks the number of audio channels of the content to play back. Information about the number of audio channels is described by the TS data, for example. And the microcomputer 157 instructs the AV decoder 154 to extract that information.

Next, in Step S202, the microcomputer 157 determines whether or not the number of audio channels is 7.1ch. If the answer is YES, the process advances to Step S203. Otherwise, the process advances to Step S204.

In Step S203, the microcomputer 157 outputs the audio of the content as a 7.1ch audio signal.

On the other hand, in Step S204, the microcomputer 157 converts the audio of the content into 7.1ch and then outputs the audio signal. For example, if the audio of the content is 5.1ch, then the microcomputer 157 outputs the left and right front signal (L/R) as the left and right surround back signal (SBL and SBR) 303 as it is.

After that, the process ends.

The details of the processing step S104 shown in FIG. 9 are shown in FIG. 11, which is a flowchart showing the procedure of outputting audio in the 2ch+5.1ch mode.

First, in Step S301, the microcomputer 157 checks the number of audio channels of the content to play back as in the processing step S201 shown in FIG. 10.

Next, in Step S302, the microcomputer 157 determines whether or not the number of audio channels is greater than 5.1ch. If the answer is YES, the process advances to Step S303. Otherwise, the process advances to Step S304.

In Step S303, the microcomputer 157 outputs the audio of the content as down-mixed 5.1ch and down-mixed 2ch audio signals. This processing step is carried out based on Equations (1) and (2) described above.

On the other hand, in Step S304, the microcomputer 157 outputs the audio of the content as 5.1ch and down-mixed 2ch audio signals. If the audio of the content has fewer channels (e.g., 2ch) than 5.1ch, then the microcomputer 157 not only generates a 5.1ch audio signal based on the audio of at least one channel but also outputs a 2ch audio signal.

After that, the process ends.

According to the configuration described above, the first switch to selectively output either the surround back signal or the down-mixed 2ch signal is arranged on the input side of the first D/A converter. Thus, the audio output device of this preferred embodiment can provide 7.1ch audio outputs for Blu-ray Discs while using 5.1ch D/A converters with the same circuit configuration and output terminal arrangement as the counterparts of a DVD player. Added to that, if a 5.1ch loudspeaker system is connected to this audio output device, then the device can provide analog 5.1ch outputs to be connected to the analog 5.1ch inputs of an AV amplifier and down-mixed 2ch outputs to be connected to the audio inputs of a TV set.

On top of that, if the user who has used the audio output device 100 in a playback environment with 5.1ch and 2ch has added two loudspeakers to reproduce surround back audio, then he or she can switch into the 7.1ch playback environment very easily. That is to say, just by connecting the two additional loudspeakers to the terminals through which the down-mixed 2ch signal has been output and by turning the first switch so as to enable the 7.1ch audio outputs, he or she can enjoy the 7.1ch audio instantly.

### EMBODIMENT 2

FIG. 12 is a schematic representation illustrating a connection and configuration for an audio output device 200 as a second specific preferred embodiment of the present invention. This is an alternative configuration that could replace that of the first preferred embodiment shown in FIG. 3. In the other components, however, the audio output device 200 of this preferred embodiment has the same configuration as the counterpart of the first preferred embodiment, and the description thereof will be omitted herein.

Hereinafter, it will be described how the audio output device shown in FIG. 12 operates. The difference between the configurations shown in FIGS. 3 and 12 is that the device shown in FIG. 12 includes a second switch (SW2) 202. This second switch 202 is added to output two 2ch signals independently of each other. In this case, one of the two 2ch signals is supposed to be connected to a TV set, while the other signal is supposed to be supplied to a 2ch audio dedicated amplifier.

The down-mixed 2ch signal 305 is input as a digital signal to the first switch 201. Likewise, the surround back signal 304 is also input as a digital signal to the first switch 201, which is controlled, and has its output signal selected, in accordance with the first control signal 401.

The first control signal 401 instructs the first switch 201 to output the surround back signal 304 if this audio output device 200 is used in a 7.1ch system but to output the down-mixed 2ch signal 305 if this audio output device 200 is used in a 5.1ch system.

On the other hand, the front signal 301 is input as a digital signal to the second switch 202. And the down-mixed 2ch signal 305 is input as a digital signal to not only the first switch 201 but also the second switch 202 as well. The second switch 202 has its output controlled in accordance with a second control signal 402.

The second control signal 402 instructs the second switch 202 to output the down-mixed 2ch signal 305 if the user has chosen 2ch connection but to output the front signal 301 if the user has chosen either 2ch+5.1ch or 7.1ch.

FIG. 13 illustrates how the audio output device 200 of this preferred embodiment may be connected when used in an environment in which a 2ch loudspeaker system is installed. Meanwhile, the playback environments for 7.1ch and 2ch+5.1ch are just as shown in FIGS. 4 and 5, and the description thereof will be omitted herein.

In FIG. 13, not just 2ch audio is output to a TV set 603 but also another 2ch audio signal is supplied independently to an AV amplifier 602. As a result, playback can be carried out using a 2ch loudspeaker system 605. Consequently, the audio output device 200 of this preferred embodiment allows the user to choose one of the three playback environments of 2ch, 2ch+5.1ch and 7.1ch.

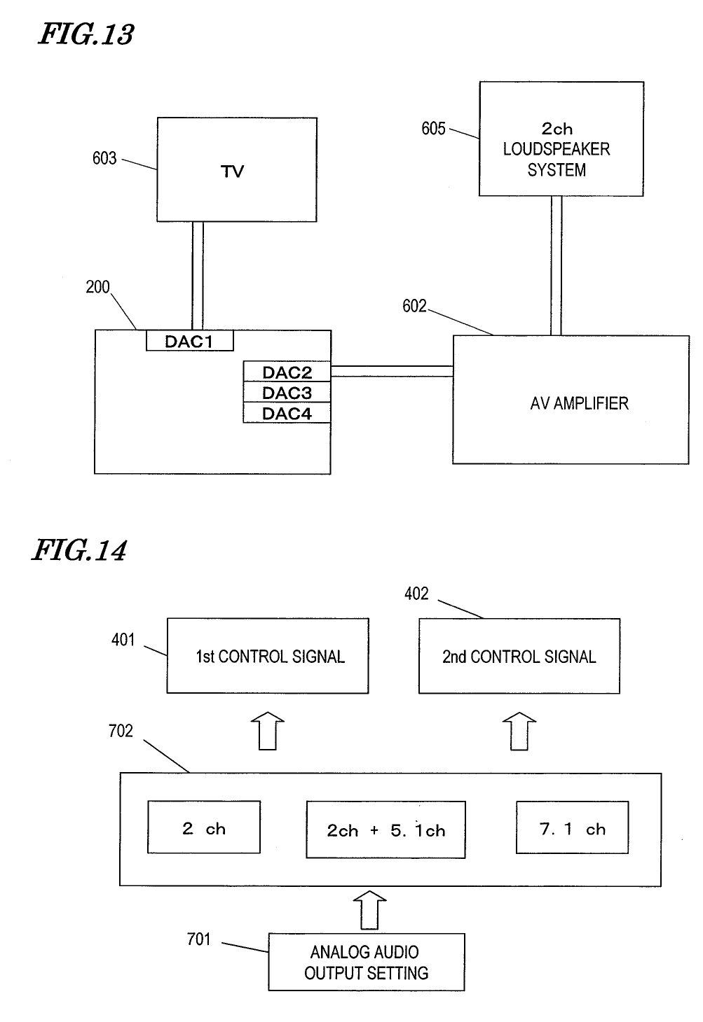

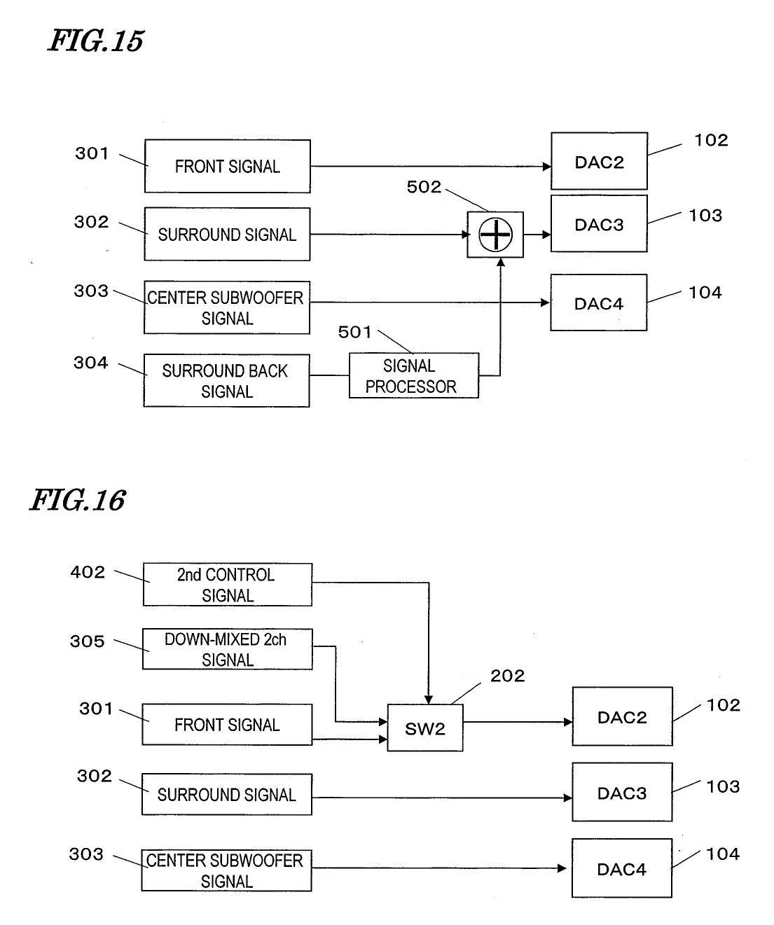

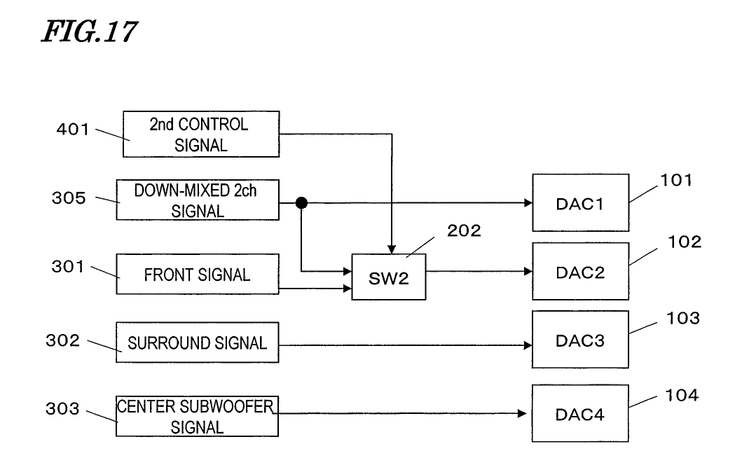

FIG. 14 illustrates exemplary dialog boxes 701 and 702 that prompt the user to choose, as the analog audio output mode, 2ch, 2ch+5.1ch or 7.1ch while setting the operating environment of the audio output device 200. This choice can be made with the user interface of the audio output device 200, for example. An analog audio output setting option 701 is provided as one of various operating environment setting options of the audio output device 200. When the user picks up that option, the dialog box 702 for making a choice is displayed. And if the user chooses one of 2ch, 2ch+5.1ch and 7.1ch, the first and second control signals 401 and 402 are determined.

Specifically, if the user chooses 7.1ch, the first switch 201 outputs the surround back signal 304 in accordance with the first control signal 401. On the other hand, if the user chooses 2ch or 2ch+5.1ch, the first switch 201 will output the down-mixed 2ch signal 305 in accordance with the control signal 401.

Meanwhile, if the user chooses 2ch, the second switch 202 outputs the down-mixed 2ch signal 305 in accordance with the second control signal 402. On the other hand, if the user chooses either 2ch+5.1ch or 7.1ch, then the second switch 202 will output the front signal 301.

Optionally, an alert such as the one shown in FIG. 7 or 8 may be presented to the user according to the connection he or she has chosen.

According to this preferred embodiment, not just can the advantages of the audio output device 100 of the first preferred embodiment be achieved but also can 2ch audio be played back by an AV amplifier or a normal amplifier without changing the settings or connection of its components.

The preferred embodiments of the present invention described above are implemented as an audio output device that has at least the mode of outputting a 7.1ch audio signal and the mode of outputting a 2ch+5.1ch audio signal. The number of required terminals (or channels) to output 7.1ch audio is eight, so is the number of required terminals (or channels) to output 2ch+5.1ch audio. If the sum of the numbers of the latter channels is equal to or smaller than the number of the former channels, multiple different playback environments are realized as long as the number of connection terminals is equal to or smaller than the maximum number.

In the foregoing description, 7.1ch, 5.1ch and 2ch playback environments, in which a so-called “home theater system” and a TV set coexist, have been described. However, such playback environments are just an example. As long as a similar configuration is adopted, the playback environment does not have to include a home theater system and a TV set. Alternatively, the present invention is also applicable to a playback environment such as a movie theater that is used to perform not only a multi-channel playback while showing the movie but also a playback in fewer channels while presenting ad video and/or public service announcements.

Also, in the preferred embodiments described above, the numbers of channels are supposed to be 7.1ch, 5.1ch and 2ch. However, this is only an example, too. Thus, the present invention is also applicable to any other combination of different numbers of channels. For example, a combination of 22.2ch, 12.2ch and 9.1ch, a combination of 12.2ch and 7.1ch+5.1ch, or a combination of 9.1ch and 7.1ch+2ch may also be adopted. Alternatively, the present invention is further applicable to a combination of 12.2ch and 9.1ch+2ch with two subwoofer signals.

A multi-channel audio output device according to the present invention uses 5.1ch D/A converters and output terminals as in a DVD player/recorder and arranges a first switch for selectively outputting a surround back signal or a down-mixed 2ch signal on the input side of a first D/A converter. As a result, the audio output device can also provide 7.1ch audio outputs for Blu-ray Discs. At the same time, if a 5.1ch loudspeaker system is used as in a conventional audio output device, the audio output device of the present invention can also provide 2ch audio outputs for a TV set and 5.1ch audio outputs for an AV amplifier. Consequently, the present invention can be used effectively in players and recorders for Blu-ray Discs on which 7.1ch audio has been recorded.

1. An audio output device having the ability to output audio signals with mutually different numbers of channels through multiple audio output sections on a channel-by-channel basis, the device having:
a first audio output mode for outputting a first audio signal with a first number of channels through the audio output sections; and
a second audio output mode for outputting second and third audio signals with second and third numbers of channels, respectively, which are both smaller than the first number, through the audio output sections simultaneously,
wherein the audio output sections for use to output the second and third audio signals in the second audio output mode are used in the first audio output mode to output the first audio signal.

2. The audio output device of claim 1, wherein the first audio signal has 7.1 channels, the second audio signal has 5.1 channels and the third audio signal has 2 channels.

3. The audio output device of claim 2, wherein among the audio output sections, the audio output section for outputting the third audio signal in the second audio output mode is the same as the audio output section for outputting a surround back signal of the first audio signal in the first audio output mode.

4. The audio output device of claim 1, wherein the sum of the second and third numbers of channels is equal to or smaller than the first number of channels.
